(19) United States
(12) Patent Application Publication
(10) Pub. No.: US 2025/0176463 A1
(43) Pub. Date: Jun. 5, 2025

(54) Predicting a Capacity for a Combine Harvester

(71) Applicant: AGCO Corporation, Duluth, GA (US)

(72) Inventors: Manish Naryal, Hesston, KS (US); Jared J. Koch, Valley Center, KS (US)

(21) Appl. No.: 18/843,139

(22) PCT Filed: Feb. 9, 2023
(86) PCT No.: PCT/IB2023/051165

§ 371 Date: Aug. 30, 2024

Related U.S. Application Data
(60) Provisional application No. 63/269,664, filed on Mar. 21, 2022.

(51) Int. Cl. A01D 41/127

(52) U.S. Cl. CPC A01D 41/1274; A01D 41/1276

(57) ABSTRACT

A mechanism for determining a maximum available capacity for one or more portions of a combine harvester. Crop standing data, terrain data and a difficulty indicator are processed in order to determine the maximum available capacity.

### CROSS-REFERENCE TO RELATED APPLICATIONS

Not applicable.

### FIELD

Embodiments of the present disclosure generally relate to the field of combine harvesting.

### BACKGROUND

With ever-increasing population numbers and ongoing interest in more environmentally friendly farming practices, there is an increasing desire to reduce waste when harvesting crop whilst increasing speed and efficiency of harvesting.

There are a number of factors that influence the efficiency of crop harvesting, and/or the amount and/or speed at which crop can be harvested, by a combine harvester. For instance, it is known that the threshing efficiency of a combine harvester that harvests cereal crops will reduce with increased moisture levels of the crop. Generally, the more difficult it proves to harvest a crop, the less efficiently a combine harvester will be able to operate.

### BRIEF SUMMARY

The invention is defined by the claims.

According to examples in accordance with an aspect of the invention, there is provided a computer-implemented method for predicting a maximum available capacity of at least one portion of a combine harvester for harvesting crop in a terrain.

The computer-implemented method comprises: obtaining crop standing data indicating a standing state of the crop; obtaining terrain data, the terrain data including a respective value or values for one or more properties of the terrain; obtaining a difficulty indicator, indicating a likely level of difficulty for cutting the crop and/or separating harvested crop using the combine harvester; and processing at least the crop standing data, the terrain data and the difficulty indicator to generate at least one capacity indicator, each capacity indicator indicating a predicted maximum available capacity of a respective portion of the combine harvester.

The maximum available capacity of a portion of the combine harvester is a measure or indicator of how much crop or material can be successfully processed by the portion of the combine harvester within a particular time period. Thus, a capacity may represent a maximum allowable throughput (within predefined safety margins) for a portion of the combine harvester.

The present invention recognizes that a maximum available capacity for different sections of a combine harvester, or the overall combine harvester, can be derived from crop standing data, terrain data and crop cutting/separation difficulty. A maximum available capacity provides useful information for identifying how much crop can be harvested in a session, which is useful information for understanding a state or condition of an ongoing harvest.

In some examples, the at least one portion of the combine harvester comprises: a feeder of the combine harvester; a threshing unit of the combine harvester; a separating unit of the combine harvester; a grain cleaning unit of the combine harvester; a tailings processing unit of the combine harvester; and/or the entire combine harvester.

The feeder of the combine harvester represents the part of the combine harvester that conveys crop cut by the header of the combine harvester to the threshing unit, and may alternatively be labelled a conveying unit. The grain cleaning unit may comprise a fan unit and one or more sieves or chaffers. The tailing processing unit may, for instance, comprise a tailings auger for returning tailing (i.e. unthreshed grain) back to the threshing unit.

The step of processing at least the crop standing state, the terrain data and the difficulty data may comprise: processing at least the crop standing state, the terrain data and the difficulty data to generate a harvesting difficulty indicator, indicating a likely level of difficulty for performing combine harvesting using the combine harvester; and processing at least the harvesting difficulty indicator and the one or more harvester parameters to generate the at least one capacity indicator.

In some examples, the method further comprises a step of modifying one or more operational components of the combine harvester responsive to the at least one capacity indicator.

The step of modifying the one or more operational components may comprise: obtaining at least one target capacity indicator, each target capacity indicator indicating a desired capacity of a respective portion of the combine harvester; and processing the at least one target capacity indicator and the at least one capacity indicator to determine, for each one or more operational component, an operating range for the operational component.

The step of modifying the one or more operational components may further comprise: monitoring a throughput of the combine harvester; and modifying each one or more operational components responsive to the monitored throughput and the determined operating range for the operational component.

Optionally, each of the one or more operational components is an operational component that controls a throughput of the combine harvester.

The one or more operational components may comprise: a power applied by a drive unit of the combine harvester; a rotor speed of a threshing unit of the combine harvester; a clearance between a threshing cylinder and a concave of a threshing unit of the combine harvester; a fan speed of a grain cleaning unit of the combine harvester; and/or a mesh size of a sieve of a grain cleaning unit of the combine harvester.

Embodiments may further comprise providing, at a user interface, a visual representation of the one or more capacity indicators.

The step of obtaining a difficulty indicator may comprise: obtaining values for a plurality of crop condition parameters, each crop condition parameter being a measurable property of the crop that changes with maturation of the crop and/or environmental conditions; obtaining values for one or more contextual parameters, each contextual parameter being a property of the crop, the combine harvester or the harvesting location; weighting the values for the plurality of crop condition parameters in dependence on the values of the one or more contextual parameters; and processing at least the weighted values of the properties to generate a difficulty indicator, the difficulty indicator indicating a likely level of difficulty for cutting the crop and/or separating harvested crop using the combine harvester.

The contextual parameter may be a property of the crop, the combine harvester or the harvesting location that is independent of any parameter of the crop that changes with maturation of the crop and/or environmental conditions.

There is also proposed a computer program product comprising computer program code means which, when executed on a computing device having a processing system, cause the processing system to perform all of the steps of any herein described method.

There is also proposed a processing system for predicting a maximum available capacity of at least one portion of a combine harvester for harvesting crop in a terrain. The processing system is configured to: obtain crop standing data indicating a standing state of the crop; obtain terrain data, the terrain data including one or more properties of the terrain; obtain a difficulty indicator, indicating a likely level of difficulty for cutting the crop and/or separating harvested crop using the combine harvester; and process at least the crop standing data, the terrain data and the difficulty indicator to generate at least one capacity indicator, each capacity indicator indicating a predicted maximum available capacity of a respective portion of the combine harvester.

The skilled person would be readily capable of adapting the processing system to perform any herein described method, and vice versa.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

These and other aspects of the invention will be apparent from and elucidated with reference to the embodiment(s) described hereinafter.

### BRIEF DESCRIPTION OF THE DRAWINGS

One or more embodiments of the invention/disclosure will now be described, by way of example only, with reference to the accompanying drawings, in which:

FIG. 1 illustrates a combine harvester;

FIG. 2 illustrates internal components of a combine harvester;

FIG. 3 is a flowchart illustrating a method according to an embodiment;

FIG. 4 is a flowchart illustrating a control method for a combine harvester;

FIG. 5 is a flowchart illustrating a method of generating a difficulty indicator;

FIG. 6 illustrates a processing system; and

FIG. 7 illustrates the processing system.

### DETAILED DESCRIPTION

The invention will be described with reference to the figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

The invention provides a mechanism for determining a maximum available capacity for one or more portions of a combine harvester. Crop standing data, terrain data and a difficulty indicator are processed in order to determine the maximum available capacity.

Embodiments are based on the realization that the amount of material that can be successfully processed (i.e., a capacity) by different portions of a combine harvester is dependent upon the harvesting conditions. It is also recognized that the harvesting conditions that most significantly impact on a capacity include a standing state of the crop; characteristics of the terrain and a difficulty in harvesting and/or separating the crop. By processing data representing these characteristics, a more accurate determination of the capacity of the portion(s) of the combine harvester can be established.

Herein disclosed approaches can be employed in any suitable environment, particularly agricultural environments, in which harvesting of crop using a combine harvester is to be performed.

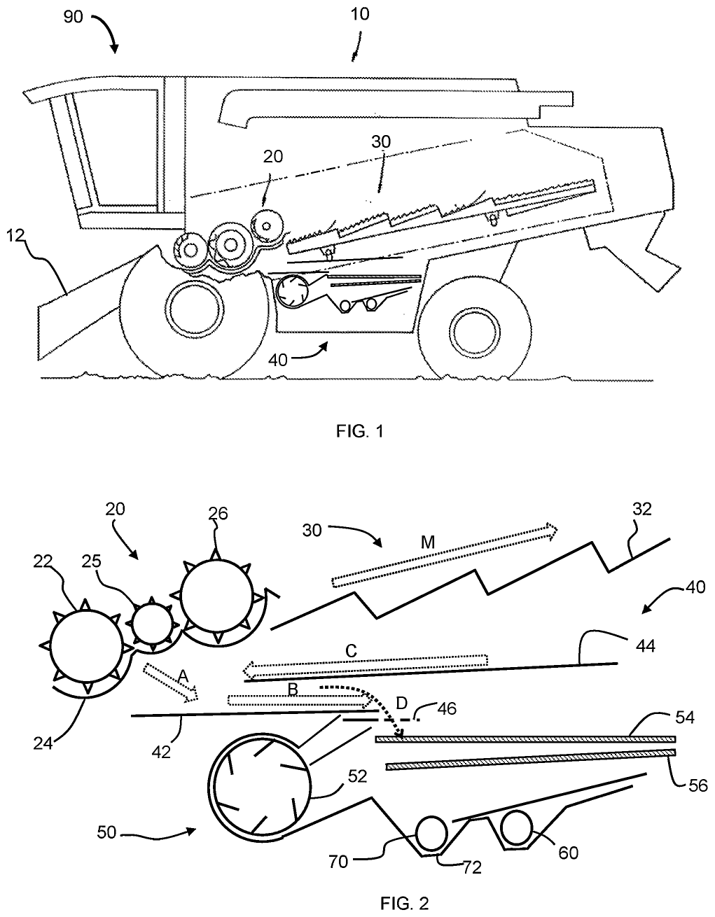

FIG. 1 conceptually illustrates a combine harvester 10, for improved contextual understanding.

FIG. 1 shows a known combine harvester 10 in which embodiments may be integrated. The combine harvester includes a threshing unit 20 for detaching grains of cereal from the ears of cereal, and a separating unit 30 which is connected downstream of the threshing unit 20. The grains after separation by the separating device 30 pass to a grain cleaning apparatus 40.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing unit 20. In the example shown, the threshing unit 20 is a transverse threshing unit, i.e. formed by rotating elements with an axis of rotation in the side-to-side direction of the combine harvester and for generating a tangential flow.

The operation of the combine harvester may be controlled by a control system (not shown). The control system may receive input from a user interface and/or sensing apparatus and control the operation of the various units and apparatus responsive to the received input.

The combine harvester 10 may also comprise a user support 90, e.g. a cab, for housing an operator/individual. The user support will often contain a user interface to allow the operator/individual to influence or control the operation of the elements of the combine harvester (e.g. via the control system). The user interface may also provide information about the combine harvester and/or the status of the combine harvester.

The threshing unit 20, separating device 30 and grain cleaning apparatus 40 are shown in more detail in FIG. 2.

FIG. 2 shows one particular design for a threshing unit, namely a traverse threshing unit. The transverse threshing unit 20 includes a rotating, tangential-flow, threshing cylinder 22 and a concave-shaped grate 24, sometimes simply called a concave. The threshing cylinder 22 includes rasp bars (not shown) which act upon the crop stream to thresh the grain or seeds from the remaining material, the majority of the threshed grain passing through the underlying grate 24 and onto a stratification pan 42 (also known as the grain pan), which for convenience is in this disclosure considered to be part of the grain cleaning apparatus 40.

The threshing unit 20 also comprises a beater cylinder 25 (also with a transverse rotation axis and creating a tangential flow), downstream of the threshing cylinder and a tangential-flow multi-crop separator cylinder 26 (also with a transverse rotation axis and creating a tangential flow) downstream of the beater cylinder 25.

The threshing unit 20 shown in this example thus has a well-known set of three transversely mounted rollers and cylinders (otherwise known as drums). However, there are other transverse rotation (and hence tangential flow) threshing units. Typically, there is at least one threshing cylinder, and often also a beater cylinder.

The remainder of the crop material including straw, tailings and un-threshed grain are passed from the threshing unit 20 into the separating unit 30 as shown by arrow M.

In the example shown, the separating unit 30 includes a plurality of parallel, longitudinally-aligned, straw walkers 32, and this is suitable for the case of a so-called straw-walker combine. However, the separating unit 30 may instead include one or two longitudinally-aligned rotors which rotate about a longitudinal axis and convey the crop stream rearwardly in a ribbon passing along a spiral path. This is the case for a so-called axial or hybrid combine harvester.

In all cases, the separating unit 30 serves to separate further grain from the crop stream, and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 and separating unit 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 (i.e. a grain cleaning unit 50) is provided to remove this unwanted material thus leaving a clean sample of grain to be delivered to the tank.

For clarity, the term ‘grain cleaning apparatus’ is intended to include the stratification pan 42, the return pan 44 and other parts which form the grain cleaning unit 50 (also known as a cleaning shoe).

The grain cleaning unit 50 also comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing unit 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56.

It is known for chaffer 54 to include an inclined rear extension section (not shown), and MOG which reaches the rear section either passes over the rear edge and out of the machine or through the associated grate before being conveyed to a returns auger 60 for re-threshing in a known manner. The materials passing through the rear end of the chaffer 54 include un-threshed tailings, chaff, straw, cobs and other MOG.

Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the tailings processing unit 60 or returns auger for reprocessing in a known manner.

The flow of material over the end of the stratification pan 42, shown as arrow D, is known as a cascade. It is desirable for this cascade to form a thin layer so that the airflow from the fan unit 52 is able to pass through the layer and lift the MOG away from the grains.

To assist this operation it is also known to have an additional cascade pan 46 between the stratification pan 42 and the chaffer 54. The grain and chaff then initially falls from the stratification pan 42 onto the cascade pan 46 before falling from the rear edge thereof onto the chaffer 54. The cascade pan 46 has a grid to convey long straw and weeds rearwardly and away from the cascading grain flow. The cascade pan assists the separation of grain from MOG.

In this case, fan unit 52 delivers a portion of a cleaning airstream rearwardly between the stratification pan 42 and the cascade pan 46 and another portion rearwardly between the chaffer 54 and the cascade pan 46, and between the sieves.

The fan unit 52 thus generates a cleaning air stream which is directed through the falling grain and chaff cascade. The fan 52 rotates on a transverse axis in a known manner and includes a plurality of impellor blades which draw in air from the transverse ends open to the environment and generate an air stream as explained above in a generally rearward direction. The air stream creates a pressure differential across the chaffer 54 and sieve 56 to encourage lighter MOG rearwardly and upwardly whilst allowing the grain to pass through the chaffer 54 and the sieve 56.

The operation of the various units and elements of the combine harvester may be controlled by a control unit (not shown). For instance, the control unit may modify one or more operational components of the combine harvester.

Embodiments of the invention relate to approaches for determining a capacity of one or more portions of the combine harvester. This information could be used, for instance, by the control unit to modify or control the behavior of different parts of the combine harvester.

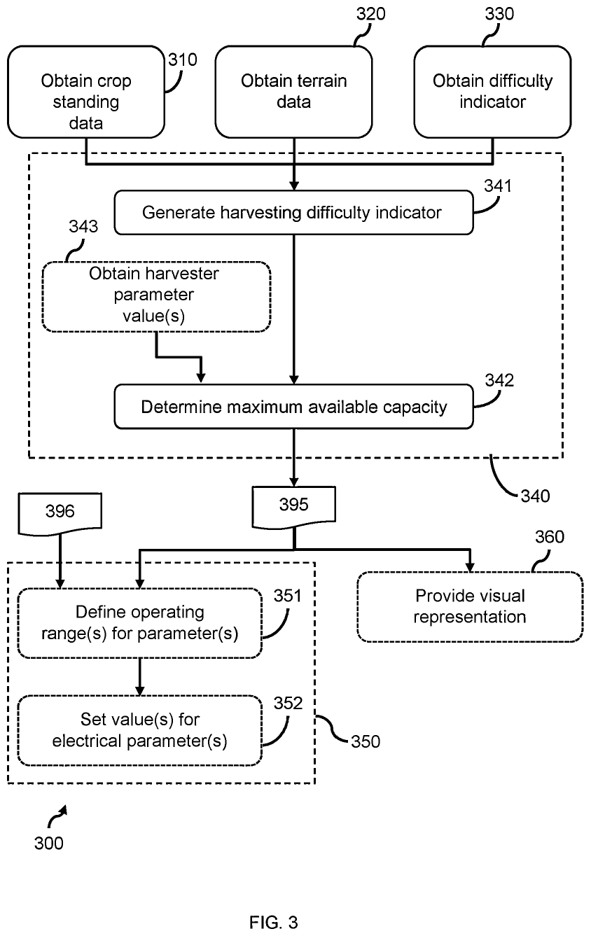

FIG. 3 illustrates a method 300 according to an embodiment. The method is configured for predicting a maximum available capacity of at least one portion of a combine harvester for harvesting crop in a terrain.

The method 300 is preferably computer-implemented, and could be executed by a processing system. This processing system may form part of the control system of the combine harvester previously illustrated.

The method 300 comprises a step 310 of obtaining crop standing data indicating a standing state of the crop.

The data obtained in step 310 may have been originally obtained or determined by one or more sensors, e.g. coupled to or forming part of the combine harvester. For instance, a sensor may be positioned and configured to analyze a standing state of the crop before it has been harvested or as the crop is being harvested, e.g. using a camera or other sensor.

In other examples, the data obtained in step 310 may be obtained by a sensor unit or arrangement that is separate to the combine harvester. For instance, the sensor arrangement may comprise a stand-alone sensing unit that analyzes a standing state of the crop. Data for a determined standing state of the crop may be passed to the processing system, e.g., using any suitable wireless or wired communication channel, or provided to the processing system by a user, e.g., via a user input.

Although possible, step 310 does not need to itself comprise the step of generating, measuring or sampling the crop standing data. For instance, step 310 may instead comprise receiving the crop standing data (e.g. at an input to a processing system) or retrieving previously generated and stored crop standing data from a memory or storage system.

Crop standing data may indicate a relative angle with which the crop to be harvested makes with respect to the vertical (e.g., with respect to gravity). The angle of the crop will affect or influence the efficiency of harvesting, and therefore a maximum available capacity of various portions of a combine harvester. For instance, the more vertical a crop, the less moisture may be held by the crop, therefore making threshing and cleaning more efficient. As another example, the more vertical a crop, the less a probability that the crop has over-matured. Over-mature crop is more difficult to thresh, separate and/or clean. Thus, there is a clear and direct link between crop standing state and maximum available capacity.

Various approaches for determining crop standing data have been identified in the prior art. A few demonstrative examples are hereafter provided.

U.S. Pat. No. 10,757,859 dated 1 Sep. 2020 by Inventor Cristian Dima et al, discloses an approach for performing downed crop detection, in which a status of crop (e.g. “standing”, “down”) is identified from a stereo camera.

U.S. Pat. No. 9,696,162 B2, dated 4 Jul. 2017 by Inventor Noel W. Anderson discloses a sensor system that is configured to determine a magnitude and/or orientation of crop, a magnitude appearing to indicate an angle the crop makes with respect to the vertical.

As another example, Sugandh Chauhan, Roshanak Darvishzadeh, Mirco Boschetti, Andrew Nelson, Estimation of crop angle of inclination for lodged wheat using multi-sensor SAR data, Remote Sensing of Environment, Volume 236, 2020,111488, discloses an approach in which a crop angle of inclination is determined from synthetic-aperture radar data.

Chinese Patent Application No. 2020/10553276 filed 17 Jun. 2020 with Inventor Wang Liusan discloses an approach for classifying crop lodging using machine-learning.

Hirai, Yasumaru, Kunihiko Hamagami, and Ken Mori. “Investigation of a Laser Scanner for Measurement of Lodging Posture of a Wheat Bunc.” JOURNAL-FACULTY OF AGRICULTURE KYUSHU UNIVERSITY 53.1 (2008): 89 discloses the use of a laser scanner for determining a lodging direction and orientation.

Any of these sensing approaches could be adopted to generate the data obtained in step 310 of the method 300. In yet other examples, the values may be generated at a user interface responsive to a user input (e.g. if an individual wishes to input data obtained from a separate sensing system).

The method 300 also comprises a step 320 of obtaining terrain data, the terrain data including a respective value or values for one or more properties of the terrain.

Suitable properties of the terrain include terrain softness, soil compaction or terrain inclination (e.g. gradient of a slope on the terrain). Generally, the properties of the terrain may include any property of the terrain (e.g. surface roughness) that will affect or impact the operation of the combine harvester, e.g. a maximum (safe) speed of the combine harvester or a processing capability of the combine harvester, e.g., if a slope will impact the threshing, separating or cleaning efficiency of the combine harvester.

Terrain data may include information on the soil type, slope and field contours, past yield maps and/or a plan for vehicle navigation etc. Terrain data may comprise any pre-harvest analysis and predictive map generated for the field using some drone or satellite imagery. By way of example only, terrain data could be generated by analyzing or processing weather data from a preceding time period (e.g., the last few days) to estimate the wetness and softness of soil using some estimation techniques known in the art.

The data obtained in step 320 may have been originally obtained or determined by one or more sensors, e.g. coupled to or forming part of the combine harvester. For instance, a sensor may be positioned and configured to analyze the terrain before crop has been harvested or as the crop is being harvested, e.g. using a camera or other sensor.

In other examples, the data obtained in step 320 may be obtained by a sensor unit or arrangement that is separate to the combine harvester. For instance, the sensor arrangement may comprise a stand-alone sensing unit that analyzes the terrain. Terrain data may be passed to the processing system, e.g., using any suitable wireless or wired communication channel, or provided to the processing system by a user, e.g., via a user input.

Although possible, step 310 does not need to itself comprise the step of generating, measuring or sampling the terrain data. For instance, step 310 may instead comprise receiving the terrain data (e.g. at an input to a processing system) or retrieving previously generated and stored terrain data from a memory or storage system.

In one example, a sensor for determining terrain data is configured to detect a difference between a first height value and a second height value. The first height value represents a vertical distance between a sensor on the combine harvester and terrain over which the combine harvester has not yet travelled, e.g., in front of the combine harvester. The second height value represents a vertical distance between a sensor on the combine harvester and terrain over which the combine harvester has travelled, e.g. behind the combine harvester. The difference is a measure of terrain compactness, i.e. terrain softness.

One suitable example of a sensor for determining a slope of a terrain is an accelerometer or other inclination detection system, which detects an inclination of the combine harvester and thereby an inclination or slope of the terrain on which the combine harvester is positioned.

Various approaches for determining terrain data have been identified in the prior art. A few demonstrative examples are hereafter provided.

European Patent No. 3,668,302 dated 11 Aug. 2021 with inventor Ole Green discloses a sensor for determining a soil compaction of an agricultural vehicle. A measure of soil compaction is one suitable example of a terrain parameter.

U.S. Pat. No. 8,985,232 B2, dated 24 Mar. 2015, with inventor Joseph Bassett discloses a soil hardness sensing device. A soil hardness is a suitable terrain property that could be employed in embodiments.

The method 300 further comprises a step 330 of obtaining a difficulty indicator, indicating a likely level of difficulty for cutting the crop and/or separating harvested crop using the combine harvester.

One in-depth example procedure for generating a difficulty indicator is provided later in this disclosure. Other approaches may comprise obtaining a difficulty indicator from a user input or a difficulty determination system. Such a difficulty determination system may be a system carried by or associated with another form of agricultural device, such as a tractor or similar.

The method 300 then performs a step 340 of processing at least the crop standing data, the terrain data and the difficulty indicator to generate at least one capacity indicator 395, each capacity indicator indicating a predicted maximum available capacity of a respective portion of the combine harvester.

The maximum available capacity of a portion of the combine harvester is a measure or indicator of how much crop or material can be successfully processed by the portion of the combine harvester within a particular time period (e.g. per unit time). Thus, a maximum available capacity may represent a maximum allowable throughput (within predefined safety margins or within acceptable yield/waste margins) for a portion of the combine harvester.

More particularly, the maximum available capacity represents a measure of how much crop/material can be processed by the portion of the combine harvester for the current harvesting conditions, i.e., the current environmental and/or crop conditions, e.g., within acceptable safety and/or yield/waste margins. “Acceptable” margins may be defined based on an operators desires or a manufacturer's guidance, amongst other potential approaches.

Embodiments have recognized that the crop standing data, the terrain data and the difficulty of harvesting/separating crop are the main or key indicators of a maximum available capacity for different portions of the combine harvester. These elements have been identified as significantly impacting upon the amount of crop/material that can be successfully processed in current harvesting conditions.

Step 340 may comprise a sub-step 341 of processing at least the crop standing state, the terrain data and the difficulty data to generate a harvesting difficulty indicator, indicating a likely level of difficulty for performing combine harvesting using the combine harvester.

In one embodiment, sub-step 341 comprises using a machine-learning algorithm to process the crop standing state, the terrain data and the difficulty data to generate the harvesting difficulty indicator. Machine-learning models provide well established and increasingly accurate approaches for predicting output data by processing input data. In the context of this sub-step, the input data comprises the crop standing data, the terrain data and the difficulty data; and the output data comprises the harvesting difficulty indicator.

Preferably, the harvesting difficulty indicator is a numeric value representing, e.g., on a predetermined numeric scale, a likely level of difficulty for performing combine harvesting using the combine harvester. The numeric scale may, for instance, be a scale of from 0 to 1, 0 to 10, 1 to 10, 0 to 100 or 1 to 100. Other suitable scales will be apparent to the skilled person.

The step 340 may then perform a sub-step 342 of determining a maximum available capacity for one or more portions of the combine harvester by processing at least the harvesting difficulty indicator.

In one example, the harvesting difficulty indicator is processed to produce an available capacity reduction factor (e.g., for each portion). The available capacity reduction factor represents the proportion or fraction of the maximum possible capacity for the portion that can be utilized. This reduction factor can be used to determine the available capacity with respect to the combine harvester's rated capacity, e.g., by multiplying the reduction factor with the rated capacity.

If the harvesting difficulty indicator is a numeric value, then it may be processed using a predetermined equation or the like to produce the reduction factor and/or the available capacity. It will be appreciated that the precise relationship (and therefore equation and/or coefficients) between a difficulty indicator and reduction factor can be linear or non-linear and will be different machine types, configurations and/or harvester parameters.

This relationship, e.g. the predetermined equation, can be determined empirically and/or statistically. Suitable approaches would be apparent to the skilled person.

In some examples, sub-step 342 may further comprise using one or more harvester parameter values, alongside the harvesting difficulty indicator, in order to generate the at least one capacity indicator. Correspondingly, in some examples, step 340 may comprise a sub-step 343 of obtaining one or more harvester parameter values.

A harvester parameter value is a value of a measureable property of the combine harvester, such as: an engine load; a rated power; and/or a total potential capacity for the one or more portions of the combine harvester. Other suitable harvester parameter values may represent the size and/or power of components of the combine harvester.

Embodiments recognize that the characteristics of the harvester itself will affect or limit the maximum available capacity for the harvesting conditions. In particular, the characteristics of the harvester may be used to define an upper limit for the maximum available capacity for the harvesting conditions.

More particularly, it is recognized that harvester parameters influence the maximum potential capacity, i.e., the rated capacity, for a portion of the combine harvester, regardless of the harvesting conditions.

By way of example, the rated power of the engine and/or the power-to-weight ratio of a harvester influences how much overall crop mass can be processed for given rest of conditions. Generally, the greater the rated power and/or power-to-weight ratio, the greater the potential capacity.

Similarly, a larger surface area of a threshing unit is able to separate grains more effectively with less grain damage, less unthreshed material and less losses. Thus, the potential capacity for a threshing unit system is dependent upon the area of size of the threshing unit.

As another example, larger sieves are able to separate grain vs MOG more effectively (without plugging the system) compared to smaller sieves. The maximum potential capacity for a grain cleaning unit is therefore dependent upon the size of the sieves.

As yet another example, the size or area of a concave area influences threshing efficiency, and therefore the maximum potential capacity for the threshing unit.

As a further example, a power and design of a fan of the grain cleaning unit also influences the cleaning capability of the system, and therefore the maximum potential capacity of the grain cleaning unit.

Yet other factors affect the maximum possible capacity for various portions of the combine harvester, such as the type of tailings system, whether or not the tailings system comprises a rethresher, whether or not the combine harvester comprises a chopper, the type and/or size of the wheels, whether the concave is regular or spring-loaded, whether the combine is a walker or rotor type, whether the rotors are axial or transverse etc.

Thus, it is apparent that a wide variety of different harvester parameter values can affect or influence the maximum potential capacity of different portions of the combine harvester, and therefore the maximum available capacity.

The method 300 may further comprise a step 350 of modifying one or more operational components of the combine harvester responsive to the at least one capacity indicator 395.

There are a wide variety of operational components of a combine harvester that would benefit from being tuned, controlled and/or otherwise modified using the at least one capacity indicator 395. An operational component may be an electrical component (e.g. a motor drive) or an electrically controlled mechanical component (e.g. a threshing cylinder) of the combine harvester.

In particular, the one or more operational components may be associated with one or more parameters that control or modify a potential speed or capacity of harvesting or processing harvested crop by the combine harvester. In this context, a (maximum) potential capacity represents a possible capacity from the perspective of the harvester (i.e. in ideal harvesting conditions).

It is recognized that parameters for many operational components of the combine harvester control the potential capacity or throughput of a portion of the combine harvester. Theoretically, is would be possible to select values for these operational components to provide a combination that would maximize a throughput of the combine harvester (e.g., maximum movement speed, maximum threshing speed and so on). Thus, there may be a maximum potential capacity for the combine harvester.

However, the actual maximum capacity or throughput is restricted by the harvesting conditions. For instance, an increased difficulty in separating crop would lead to a reduced actual capacity. Each capacity indicator indicates the maximum available capacity for a portion of the combine harvester based on current harvesting conditions (e.g., due to environmental factors). Thus, the maximum available capacity represents a possible capacity from the perspective of the harvesting conditions.

This recognition means that the value(s) for the parameter(s) of the operational component(s) can be advantageously selected based on the capacity indicator(s), e.g. to avoid the operational components from attempting to operate at a level that would (in theory) have a higher potential capacity than the maximum available capacity for current harvesting conditions—which would lead to wasted energy and/or crop. In other words, the parameter(s) of the operational component(s) may be controlled to control the potential capacity (from the perspective of the harvester) based on the determined maximum available capacity (from the perspective of the harvesting conditions).

In some examples, step 350 comprises performing a sub-step 351 of using the least one capacity indicator to define an operating range for one or more components of the combine harvester.

An operating range may define allowable values for the parameter(s) of the one or more operational components. Setting on operating range may comprise setting an upper bound and/or a lower bound for a parameter of an operational component. By setting the operating range based on the one or more capacity indicators, the combine harvester is able to avoid circumstances where a component is operating beyond its maximum available capacity (for the harvesting conditions), which would waste energy.

In particular, the operating range may be defined so that the parameters of the machine are able to achieve or target maximum available capacity, whilst avoiding circumstances where it may be operating at reduced actual capacity.

The relationship between the value(s) of the parameter(s) of the operational component(s) of the combine harvester and potential capacity may be known or predetermined. This data could, for instance, be generated by monitoring a capacity of portions of the combine harvester (in “ideal” or near-ideal harvesting conditions) for different values of the parameter(s) of the operational component(s).

Such a known or predetermined relationship may be used to define the bound(s) of the value(s) of the parameter(s) of the operational component(s) using the at least one capacity indicator, e.g. to prevent the value of the parameter reaching a value that would be used for a potential capacity that exceeds a maximum available capacity for the harvesting conditions.

By way of a simple example, if the capacity indicator indicates a maximum available capacity for a feeder of the combine harvester, the bounds of the speed for a feeder elevator (that moves harvested crop to the threshing unit) may be set so that a potential capacity of the feeder does not exceed the maximum available capacity of the feeder. In some examples, e.g., if controlling the speed of the feeder is not possible, the (ground) speed of the overall combine harvester may be controlled to effectively control the potential capacity of the feeder. Reduced speed of the combine harvester results in reduced speed of the feeder.

As another example, if a capacity indicator indicates a maximum available capacity for a threshing unit of the combine harvester (e.g. for particular harvesting conditions), the bounds for a speed of a beater or threshing cylinder of the threshing unit may be set so that a potential capacity of the threshing unit does not exceed the maximum available capacity for the threshing unit.

As another example, if a capacity indicator indicates a maximum available capacity for a cleaning unit of the combine harvester, the bounds for a speed of a pan and/or sieve aperture size of the cleaning unit maybe set so that the potential capacity of the cleaning unit does not exceed the maximum available capacity for the cleaning unit.

Suitable examples of parameters of one or more components of the combine harvester that could be modified using the at least one capacity indicator include: a power applied by a drive unit of the combine harvester (e.g., controlling a forward speed of the combine harvester); a rotor speed of a threshing unit of the combine harvester; a clearance between a threshing cylinder and a concave of a threshing unit of the combine harvester; a fan speed of a grain cleaning unit of the combine harvester; and/or a mesh/aperture size of a sieve of a grain cleaning unit of the combine harvester. Other examples would be apparent to the suitable skilled person.

The specific parameter(s) and/or component(s) for which the range(s) are set by step 351 may depend upon the portion(s) associated with the capacity indicator(s). For instance, if the at least one capacity indicator comprises only a single capacity indicator for the threshing unit, then this capacity indicator may be used to define the range(s) for the parameter(s) of the component(s) of the threshing unit, or components affect by the operation of the threshing unit.

It will also be appreciated that the maximum available capacity for one portion of the combine harvester may have an impact on the maximum available capacity for another portion of the combine harvester.

From the foregoing, it will be apparent that step 350 may comprise a sub-step 351 of processing at least the capacity indicator(s) 395 to determine, for each one or more operational component, an operating range for the operational component.

In some examples, sub-step 351 may further use at least one target capacity indicator 396 in determining the operating range for the operational component. Each target capacity indicator may indicate a desired capacity of a respective portion of the combine harvester.

A target capacity indicator 396 may be determined automatically and/or manually, e.g., by an individual providing a desired target capacity through a user interface. Approaches for determining a target capacity may include, for instance, determining a target capacity for the respective portion of the combine harvester based on crop and/or harvesting information, e.g., amount of crop to be harvested, type of crop to be harvested, time period available for harvesting crop, moisture content of crop to be harvested and so on.

The step 350 of controlling the operational component(s) may comprise a step 352 of setting the value(s) for the parameter(s) of the operational component(s) based on the determined range(s) for the value(s) and one or more other input parameter values.

In this way, the operation of the combine harvester can be controlled based on the defined range(s) and other input parameters. The other input parameters may include, for instance, a measured throughput, measured loss, measured crop quality and so on.

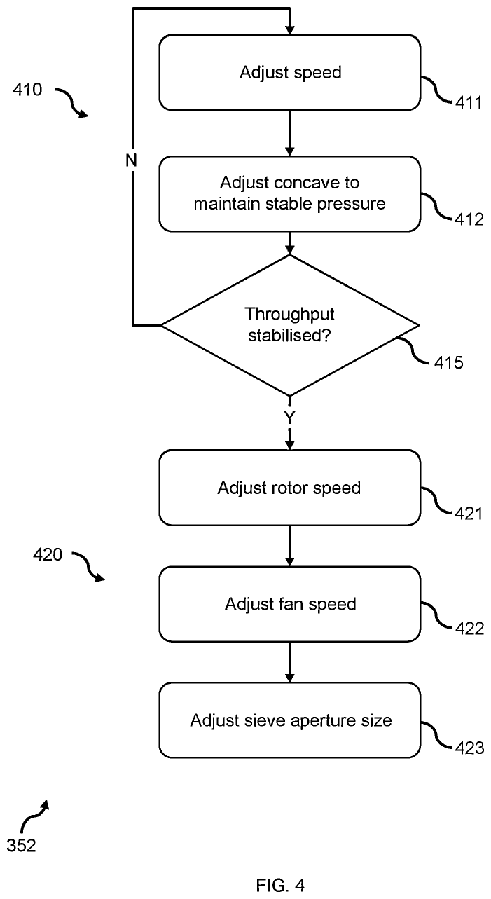

FIG. 4 illustrates one embodiment of an approach for performing step 352. In this embodiment, the one or more other input parameter values includes: a measured concave pressure (i.e. a pressure between the threshing cylinder and the concave); a measured throughput; a measured crop quality and a measured loss (of crop).

The illustrated embodiment is generally split into two parts, a course adjustment part 410 and a fine adjustment part 420. Each part controls the value(s) of the parameter(s) of the component(s) of the combine harvester, the value(s) being set within the ranges previously determined from at least the capacity indicator(s).

The sub-step 352 first comprises a step 411 of adjusting a (ground) speed of the combine harvester. This may comprise modifying a power supplied to a drive unit of the combine harvesting.

The sub-step 352 then comprises a step 412 of adjusting a clearance between the threshing cylinder and the concave of the threshing unit of the combine harvester to modify a pressure there between. This clearance is modified to maintain a stable pressure.

The sub-step 352 then determines or identifies, in a determination step 415, whether a throughput is stabilized for the current value(s) of the parameter(s). This may be performed by monitoring the measured throughput of the combine harvester, to ensure that it stays within a predetermined throughput variation.

If the throughput is not stabilized, the sub-step 352 reverts back to step 411.

Otherwise, the sub-step 352 moves to the fine adjustment part, beginning a step 421 of adjusting the rotor speed of the threshing unit. The rotor speed may be adjusted to balance an amount of unthreshed and broken crop. This may be performed using a cost function or the like.

The sub-step 352 then moves to a step 422 of adjusting a fan speed of the grain cleaning unit/apparatus of the combine harvester. The fan speed may be adjusted to balance cleanliness (of the grain cleaning unit) against a number of tailing and an amount of grain/crop loss. This may be performed using a cost function or the like.

For the avoidance of doubt, it is noted that steps 411, 412 form part of the course adjustment part 410. Steps 421, 422, 423 form part of the fine adjustment part 420.

Throughout the modification of the value(s) of the parameter(s), as previously explained, the value(s) are kept within the corresponding range(s) determined using the at least one capacity indicator.

Turning back to FIG. 3, the method 300 may further comprise a step 360 of providing, at a user interface, a visual representation of the at least one capacity indicator. Thus, step 360 may comprise controlling a display to provide or display the at least one capacity indicator. This can be used to provide an individual with useful information about the capabilities of the combine harvester for the current harvesting conditions. In particular, this aids an operator in performing a harvesting decision process, to decide how to harvest (or what parameters to use in harvesting).

It has previously been described how a difficulty indicator is used in the generation of the at least one capacity indicator. The difficulty indicator indicates a likely level of difficulty for cutting the crop and/or separating harvested crop using the combine harvester. An example approach for generating a difficulty indicator is hereafter described, for the sake of completion.

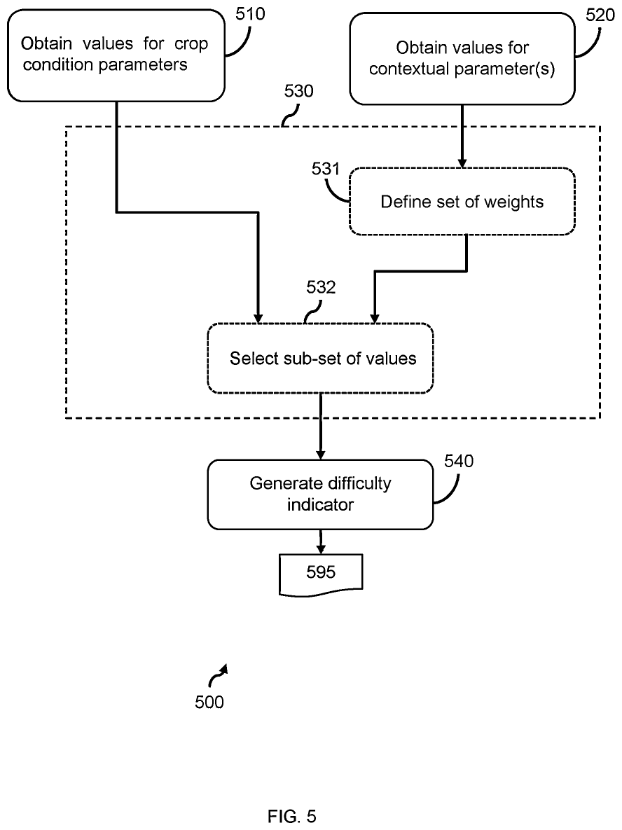

FIG. 5 illustrates a method 500 for generating a difficulty indicator. The method 500 is preferably computer-implemented, and could be executed by a processing system. This processing system may form part of the control system of the combine harvester previously illustrated.

The method 500 comprises a step 510 of obtaining values for a plurality of crop condition parameters, each crop condition parameter being a measurable property of the crop that changes with maturation of the crop and/or environmental conditions.

The values obtained in step 510 may have been originally sampled by one or more sensors, e.g. coupled to or forming part of the combine harvester. For instance, a sensor may be positioned and configured to analyze crop after it has been cut and collected by the header of the combine harvester (e.g. as it is being moved in the front elevator housing). As yet another example, crop residue, such as material-other-than-grain (MOG)—also known as non-grain material, could be analyzed to generate information about crop conditions. As another example, the sensor may be positioned and configured to analyze crop before it has been cut or collected by the combine harvester, e.g. whilst it is still standing in the field.

In other examples, the values obtained in step 510 may be obtained by a sensor unit or arrangement that is separate to the combine harvester. For instance, the sensor arrangement may comprise a stand-alone sensing unit that analyzes one or more crop condition parameters.

Although possible, step 510 does not need to itself comprise the step of generating, measuring or sampling the values for the plurality of crop condition parameters. For instance, step 510 may instead comprise receiving the values (e.g. at an input to a processing system) or retrieving previously generated and stored values from a memory or storage system.

Examples of suitable crop condition parameters include: a quantity of the crop; a quantity of crop per unit area; a moisture content of non-grain material (MOG); a moisture content of the crop; a level of decomposition of the crop; a standing state of the crop; a diameter of a stalk of the crop; a height of the crop; a temperature of the crop; and/or a ratio of grain to non-grain material in harvested crop.

Various approaches for obtaining or deriving values for crop condition parameters are well known in the art. A few demonstrative examples are hereafter provided.

U.S. Pat. No. 6,185,990 B1, dated 13 Feb. 5001 by Inventor B.M.A. Missotten et al., discloses a method and device for assessing the humidity or moisture content of a crop, which makes use on the electrical conductivity of incoming crop. This same document also discloses an approach for determining a crop density (i.e. a quantity of crop per unit area).

US Patent Application having publication number US 5021/015039 A1, published 51 Jan. 5021 by Inventor Nathan R. Vandike et al, discloses an approach for analyzing crop residence (i.e. MOG) to derive one or more crop residue parameters. A crop residue parameter (such as crop residue moisture or crop residue dispersion) may represent a crop condition parameter for use in embodiments of this disclosure.

U.S. Pat. No. 9,301,446 B2, dated 5 Apr. 5016 by Inventor Ole Peters et al, discloses various approaches for assessing crop to be harvested by a combine harvester. In particular, this document proposes approaches for determining a quantity of crop, a standing state of the crop and a moisture level of the crop. Any of these parameters may act as a crop condition parameter for use in embodiments.

German Patent Application No. DE 10346541 A, published 14 Jul. 5005 by Inventor Ehlert Detlef et al, proposes an approach for monitoring plant (crop) density using a vehicle-mounted sensor.

U.S. Pat. No. 5,106,339 A, published 51 Apr. 1994 by Inventor Braun Keith et al, proposes moisture and temperatures sensors for grain that are integrated with a combine harvester.

Any of these sensing approaches could be adopted to generate the values that are obtained in step 510 of the method 500. In yet other examples, the values may be generated at a user interface responsive to a user input (e.g. if an individual wishes to input values obtained from a separate sensing system).

The method 500 also comprises a step 520 of obtaining values for one or more contextual parameters, each contextual parameter being a property of the crop, the combine harvester or the harvesting location. A contextual parameter provides background or supplementary information about the crop, harvester or harvesting location that contextualizes the crop condition parameters.

The contextual parameter may be a parameter that is independent of any parameter of the crop that changes with maturation of the crop and/or environmental conditions. In other words, the contextual parameter may be a non-condition dependent parameter. In this way, the contextual parameter may be a “long-term” parameter that is unlikely to quickly change (e.g. during the course of harvesting).

Suitable examples of properties of the crop include a crop type, a crop variety or both. Information on these properties may be defined, for instance, by a user or individual providing this information at a user interface.

Suitable examples of properties of the combine harvester: a type of combine harvester; a type of engine; a width of a header of the combine harvester; a type of the header of the combine harvester; an identifier of whether the combine harvester operates using an axial or transverse mechanism; a rotor configuration of the combine harvester; and/or a drive configuration of the combine harvester.

One or more properties of the combine harvester may therefore be predefined. For instance, if the method is performed by a processing system for a particular combine harvested then some information about the combine harvester will be defined in advance (e.g. the type of combine harvester, the type of engine, an identifier of whether the combine harvester operates using an axial or transverse mechanism, a rotor configuration of the combine harvester; and/or a drive configuration of the combine harvester).

Similarly, one or more properties of the combine harvester may need to be defined or identified, e.g. depending upon the state or mode of operation of the combine harvester. This may be determined automatically (e.g. by identifying the mode of operation of the combine harvester) or in response to a user input. As an example, a type of the header of the combine harvester could be defined by a user inputting (at a user interface) an identifier of the type of header, or through automatic determination of the type of header (e.g. based on an exchange of information between the header and the rest of the combine harvester).

Suitable examples of properties of the harvesting location include: a temperature of the harvesting location, a global position of the harvesting location and so on. One or more of these properties may be monitored automatically (e.g. using a temperature sensor or satellite navigation sensor), or may be provided by a user/individual, e.g. via a user interface.

The method 500 then performs step 530 of weighting the values for the plurality of crop condition parameters in dependence on the values of the one or more contextual parameters. In the context of the present disclosure, weighting refers to a process of multiplying a value of a crop condition parameters by a particular value (or “weight”) to control a relative extent to which that value contributes during later processing.

Thus, the weighting of the values for the plurality of crop condition parameters is responsive to or based on the values of the one or more contextual parameters. Thus, as the values of the one or more contextual parameters changes, so the weighting of the values for the plurality of crop condition parameters changes.

In the illustrated example, step 530 comprises a step 531 of determining or defining a set of weights to weight the values of the one or more contextual parameters. Step 531 may be performed independently of the values for the plurality of crop condition parameters, e.g. before the values have been measured/sampled or before they are otherwise available for processing by the method.

In this way, a weight may be generated for each contextual parameter. The weight may define an extent to which a value of that contextual parameter contributes to later processing of the values.

In one or more examples, the weighting performed in step 530 may define which of the crop condition parameters are used in later processing. Thus, step 530 may comprise a step 532 of selecting only a subset (i.e. not all) of the values of the crop condition parameters for further processing by the method. Effectively, this applies a weighting of 0 to at least some of the values of the crop condition parameters.

This approach recognizes that some crop condition parameters will not affect a difficulty of harvesting depending upon contextual information.

The approach in which only a subset of the values are used for further processing effectively represents different processing configurations for different contexts of the harvesting. In this way, a different processing configuration of the crop condition parameters is performed dependent upon the context in which the harvesting will take place.

The method 500 then moves to a step or process 540 of processing at least the weighted values of the properties to generate a difficulty indicator 595. The difficulty indicator indicates a likely level of difficulty for cutting the crop and/or separating harvested crop using the combine harvester. Generally, the greater the difficulty of harvesting, the lower the efficiency of the combine harvester.

The difficulty indicator 595 may provide a categorical value representing a predicted level of difficulty for crop cutting and/or separation by the combine harvester. For instance, the difficulty indicator may provide a value of “Excellent”: indicating that there is no significant factor that would result in the loss of capacity. As another example, the difficulty indicator may have a value of “Good”: indicating that there is a slight difficulty in harvesting or separating harvested crop during the course of harvesting. As yet another example, the difficulty indicator may have a value of “Average”: indicating there is mild to moderate difficulty in harvesting or separating harvested crop during the course of harvesting. As yet another example, the difficulty indicator may have a value of “Poor”: indicating there is severe difficulty in harvesting or separating harvested crop during the course of harvesting.

However, other suitable examples for a difficulty indicator would be apparent to the skilled person. For instance, the difficulty indicator may comprise a numeric indicator (e.g. on a predetermined scale, such as 0 to 1, 0 to 10, 1 to 10, 0 to 100 or 1 to 100) of the predicted difficulty of harvesting.

In some examples, step 540 processes further (unweighted) values (in addition to the weighted values) to generate the difficulty indicator. In particular, some crop condition parameters for determining difficulty may be important regardless of the context, such that they undergo no weighting before being processed in step 540. One suitable example includes a MOG moisture level.

As one example, step 540 may comprise comparing each weighted value (and optionally further values) to one or more predetermined ranges. The one or more predetermined ranges may differ for each weighted value.

Consider a scenario in which the difficulty indicator may provide a value of “Excellent”, “Good”, “Average” or “Poor”. In this scenario, each weighted value (or further value) that is used may be associated with a predetermined range for each possible value of the difficulty indicator, i.e. four predetermined ranges—an “Excellent” range, a “Good” range, an “Average” range and a “Poor” range. If each weighted value falls, i.e. all weighted values fall, within an “Excellent” range for that value, then the difficulty indicator may provide a value of “Excellent”. If each weight value falls within either a “Good” or “Excellent” range for that value, and at least one value falls within the “Good” range for that value, then the difficulty indicator may provide a value of “Good”. If each weight value falls within an “Average”, “Good” or “Excellent” range for that value, and at least one value falls within the “Average” range for that value, then the difficulty indicator may provide a value of “Average”. If any weight value falls within a “Poor” range for that value, then the difficulty indicator may provide a value of “Poor”.

The values of the ranges may be chosen or determined empirically, e.g. based on historic and/or expert understanding of the effect of crop conditions.

If a weighted value is 0, then the weighted value may be ignored for the purposes of determining whether the difficulty indicator should be “Excellent”, “Good”, “Average” or “Poor”. This prevents weighted values that should not contribute to determining the difficulty of cutting crop to be harvested and/or separating harvested crop at a harvesting location using a combine harvester from affecting the outcome of step 540.

As one example, step 540 may comprise processing the weighted values (and optionally further values) using a machine-learning model to generate the difficulty indicator.

Machine-learning models provide well established and increasingly accurate approaches for predicting output data by processing input data. In the context of this step, the input data comprises the weighted values (and optionally further values) and the output data comprises the difficulty indicator.

The combination of steps 530 and 540 thereby results in the difficulty indicator 595 being dependent upon weighted values for a plurality of crop condition parameters.

In one working example, some crop condition parameters may only be relevant for establishing the difficulty of cutting and/or separating certain types or variety of crops.

For instance, a ratio of amount of MOG to ear size may only affect cutting or separating efficiency (i.e. difficulty) when the crop is corn or maize—but can still represent an important parameter for assessing an ease of separating such crop.

As another example, the sensitivity of a difficulty of harvesting a particular crop may change responsive to a type of the crop. For example, wheat should be harvested at moisture levels between 14% and 50%, whereas corn should be harvested at moisture levels between 52% and 55%. Embodiments recognize that this difference means that the contribution of moisture level to a crop cutting or separating difficulty is less for some crop types than others, which can be taken into account when generating the difficulty indicator.

For another working example, the type of the combine harvester may result in certain crop condition parameters having no influence on the difficulty in cutting and/or separating. For instance, certain brands, versions or lines of combine harvesters may perform equally efficiently for different values of a particular crop condition (e.g. crop temperature or diameter of a stalk). In this way, the contribution of such crop condition parameters to determining the difficulty may be zero.

These examples demonstrate the advantage of weighting crop condition parameters based on contextual information or contextual parameters before generating the difficulty indicator. In particular, this weighting facilitates improved efficiency in determining a difficulty of cutting crop to be harvested and/or separating harvested crop at a harvesting location using a combine harvester.

Some embodiments of the invention make use of one or more machine-learning methods. Any suitable machine-learning model may be used in different embodiments for the present disclosure. Suitable machine-learning models include (artificial) neural networks, support vector machines (SVMs), Naïve Bayesian models and decision tree algorithms, although other appropriate examples will be apparent to the skilled person.

There are a number of well-established approaches for training a machine-learning model. Typically, such training approaches make use of a large database of known input and output data. The machine-learning model is modified until an error between predicted output data, obtained by processing the input data with the machine-learning model, and the actual (known) output data is close to zero, i.e. until the predicted output data and the known output data converge. The value of this error is often defined by a cost function. The precise mechanism for modifying the machine-learning model depends upon the type of model. Example approaches for use with a neural network include gradient descent, backpropagation algorithms and so on.

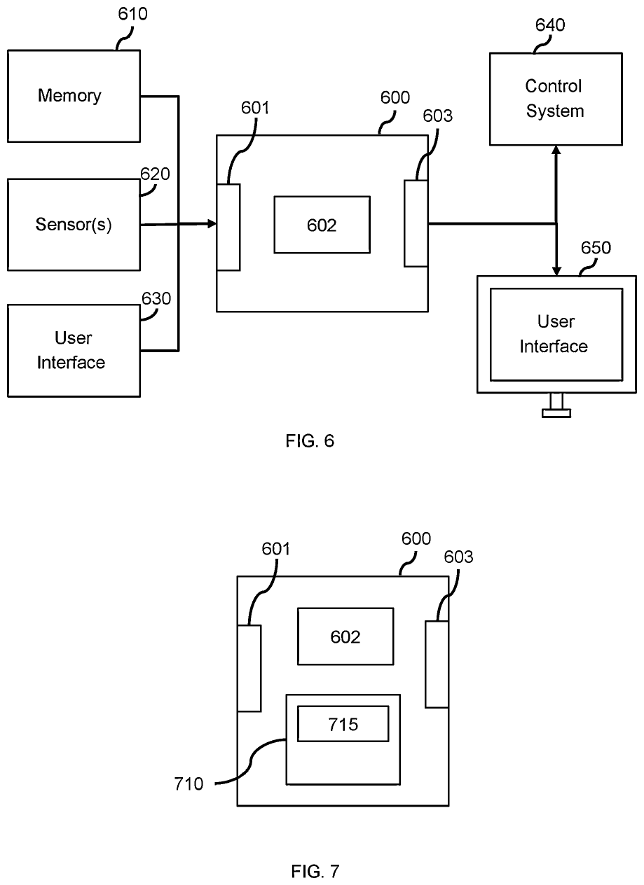

FIG. 6 illustrates a processing system 600 according to an embodiment. The processing system is configured to perform any herein described method 200.

The processing system 600 may thereby receive or obtain crop standing data, terrain data and a difficulty indicator. The processing system may receive these values from a memory or storage unit 610 and/or from one or more sensors 620 and/or from a user interface 630.

The processing system 600 may comprise an input interface 601 configured to receive all of the above-identified data.

The processing system 600 is configured to process at least the crop standing data, the terrain data and the difficulty indicator to generate at least one capacity indicator. Each capacity indicator indicating a predicted maximum available capacity of a respective portion of the combine harvester. This process may be carried out by a processing unit 602 of the processing system 600.

The processing system 600 may be configured to provide the at least one capacity indicator to a control system 640, e.g. for modifying one or more operational components of the combine harvester responsive to the at least one capacity indicator. Example approaches for modifying one or more operational components using at least one capacity indicator have been previously described. In some examples, the control system 640 itself forms part of the processing system.

The processing system 600 may be configured to control a user interface 660 to provide at a user interface, a visual representation of the difficulty indicator.

Any output of the processing system may be controlled via an output interface 603. In particular, the output of the processing system may be defined by the processing unit 602 of the processing system via the processing unit.

FIG. 7 illustrates an embodiment of the processing system 600 described with reference to FIG. 6. The processing system is able to carry out or perform one or more embodiments of an invention, e.g. for predicting a difficulty of cutting crop to be harvested and/or separating harvested crop at a harvesting location using a combine harvester.

The processing system 600 comprises an input interface 601 that receives communications from one or more inputting devices. Examples of suitable inputting devices include external memories, user interfaces (such as mice, keyboards, microphones, sensors and so on).

The processing system 600 also comprises a processing unit 602.

In one example, the processing unit 602 may comprise an appropriately programmed or configured single-purpose processing device. Examples may include appropriately programmed field-programmable gate arrays or complex programmable logic devices.

As another example, the processing unit may comprise a general purpose processing system (e.g. a general purpose processor or microprocessor) that executes a computer program 715 comprising code (e.g. instructions and/or software) carried by a memory 710 of the processing system 600.

The memory 710 may be formed from any suitable volatile or non-volatile computer storage element, e.g. FLASH memory, RAM, DRAM, SRAM, EPROM, PROM, CD-ROM and so on. Suitable memory architectures and types are well known to the person skilled in the art.

The computer program 715, e.g. the software, carried by the memory 710 may include comprise a sequence of instructions that are executable by the processing unit for implementing logical functions to carry out the desired method or procedure. Each instruction may represent a different logical function, step or sub-step used in performing a method or process according to an embodiment. The computer-program may be formed from a set of sub-programs, as would be known to the skilled person. The computer program 715 may be written in any suitable programming language that can be interpreted by the processing unit 602 for executing the instructions. Suitable programming languages are well known to the skilled person.

The processing system 600 also comprises an output interface 603. The processing system may be configured to provide information, such as the difficulty indicator, via the output interface. In some examples, the processing system may be configured to control one or more other devices connected to the output interface 603 by providing appropriate control signals to the one or more other devices. Suitable control examples include controlling a visual representation (e.g. of the difficulty indicator) at a user interface or controlling the operation of one or more other components (e.g. the drive system, threshing unit or separating unit) of the combine harvester.

Different components of the processing system 600 may interact or communicate with one another via one or more intra-system communication systems (not shown), which may include communication buses, wired interconnects, analogue electronics, wireless communication channels (e.g. the internet) and so on. Such intra-system communication systems would be well known to the skilled person.

It is not essential for the processing system 600 to be formed on a single device, e.g. a single computer. Rather, any of the system blocks (or parts of system blocks) of the illustrated processing system may be distributed across one or more computers.

The skilled person would be readily capable of developing a processing system for carrying out any herein described method. Thus, each step of the flow chart may represent a different action performed by a processing system, and may be performed by a respective module of the processing system.

It will be understood that disclosed methods are preferably computer-implemented methods. As such, there is also proposed the concept of a computer program comprising code means for implementing any described method when said program is run on a processing system, such as a computer. Thus, different portions, lines or blocks of code of a computer program according to an embodiment may be executed by a processing system or computer to perform any herein described method.

A computer program may be stored on a computer-readable medium, itself an embodiment of the invention. A “computer-readable medium” is any suitable mechanism or format that can store a program for later processing by a processing unit. The computer readable medium can be, for example but not limited to, an electronic, magnetic, optical, electromagnetic, infrared, or semiconductor system, apparatus or device. The computer-readable medium is preferably non-transitory.

In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa. Any reference signs in the claims should not be construed as limiting the scope.

All references cited herein are incorporated herein in their entireties. If there is a conflict between definitions herein and in an incorporated reference, the definition herein shall control.

1. A computer-implemented method for predicting a maximum available capacity of at least one portion of a combine harvester for harvesting crop in a terrain, the computer-implemented method comprising:
obtaining crop standing data indicating a standing state of the crop;
obtaining terrain data, the terrain data including a respective value or values for one or more properties of the terrain;
obtaining a difficulty indicator, indicating a likely level of difficulty for cutting the crop and/or separating harvested crop using the combine harvester; and
processing at least the crop standing data, the terrain data and the difficulty indicator to generate at least one capacity indicator, each capacity indicator indicating a predicted maximum available capacity of a respective portion of the combine harvester.

2. The computer-implemented method of claim 1, wherein the at least one portion of the combine harvester comprises: a feeder of the combine harvester; a threshing unit of the combine harvester; a separating unit of the combine harvester; a grain cleaning unit of the combine harvester; a tailings processing unit of the combine harvester; and/or the entire combine harvester.

3. The computer-implemented method of claim 1, wherein the step of processing at least the crop standing state, the terrain data and the difficulty data comprises:
processing at least the crop standing state, the terrain data and the difficulty data to generate a harvesting difficulty indicator, indicating a likely level of difficulty for performing combine harvesting using the combine harvester; and
processing at least the harvesting difficulty indicator and the one or more harvester parameters to generate the at least one capacity indicator.

4. The computer-implemented method of claim 1, further comprising a step of modifying one or more operational components of the combine harvester responsive to the at least one capacity indicator.

5. The computer-implemented method of claim 4, wherein the step of modifying the one or more operational components comprises:
obtaining at least one target capacity indicator, each target capacity indicator indicating a desired capacity of a respective portion of the combine harvester; and
processing the at least one target capacity indicator and the at least one capacity indicator to determine, for each one or more operational component, an operating range for the operational component.

6. The computer-implemented method of claim 5, wherein the step of modifying the one or more operational components further comprises:
monitoring a throughput of the combine harvester; and
modifying each one or more operational components responsive to the monitored throughput and the determined operating range for the operational component.

7. The computer-implemented method of claim 4, wherein each of the one or more operational components is an operational component that controls a throughput of the combine harvester.

8. The computer-implemented method of claim 7, wherein the one or more operational components comprises: a power applied by a drive unit of the combine harvester; a rotor speed of a threshing unit of the combine harvester; a clearance between a threshing cylinder and a concave of a threshing unit of the combine harvester; a fan speed of a grain cleaning unit of the combine harvester; and/or a mesh size of a sieve of a grain cleaning unit of the combine harvester.

9. The computer-implemented method of claim 1, further comprising providing, at a user interface, a visual representation of the one or more capacity indicators.

10. The computer-implemented method of claim 1, wherein the step of obtaining a difficulty indicator comprises:
obtaining values for a plurality of crop condition parameters, each crop condition parameter being a measurable property of the crop that changes with maturation of the crop and/or environmental conditions;
obtaining values for one or more contextual parameters, each contextual parameter being a property of the crop, the combine harvester or the harvesting location;
weighting the values for the plurality of crop condition parameters in dependence on the values of the one or more contextual parameters; and
processing at least the weighted values of the properties to generate a difficulty indicator, the difficulty indicator indicating a likely level of difficulty for cutting the crop and/or separating harvested crop using the combine harvester.

11. The computer-implemented method of claim 10, wherein the contextual parameter is a property of the crop, the combine harvester or the harvesting location that is independent of any parameter of the crop that changes with maturation of the crop and/or environmental conditions.

12. A computer program product comprising computer program code means which, when executed on a computing device having a processing system, cause the processing system to perform all of the steps of the method according to claim 1.

13. A processing system for predicting a maximum available capacity of at least one portion of a combine harvester for harvesting crop in a terrain, the processing system being configured to:
obtain crop standing data indicating a standing state of the crop;
obtain terrain data, the terrain data including one or more properties of the terrain;
obtain a difficulty indicator, indicating a likely level of difficulty for cutting the crop and/or separating harvested crop using the combine harvester; and
process at least the crop standing data, the terrain data and the difficulty indicator to generate at least one capacity indicator, each capacity indicator indicating a predicted maximum available capacity of a respective portion of the combine harvester.
